(19) United States
(12) Patent Application Publication
(10) Pub. No.: US 2007/0172668 A1
(43) Pub. Date: Jul. 26, 2007

(54) Cer compounds used as initiators for dual curing

(75) Inventors: Nick Gruber, Mannheim (DE); Reinhold Schwalm, Wachenheim (DE); Erich Beck, Ladenburg (DE); Yvonne Heischkel, Mannheim (DE); Christian Decker, Mulhouse (FR); Katia Studer, Mulhouse (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/590,525

(22) PCT Filed: Mar. 15, 2005
(86) PCT No.: PCT/EP05/02733

§ 371 Date: Aug. 24, 2006

(30) Foreign Application Priority Data
Mar. 17, 2004 (DE) 10 2004 013 391.3

(51) Int. Cl. B32B 27/40; C08L 75/00; C08G 18/08

(52) U.S. Cl. 428/423.1; 524/589

(57) ABSTRACT

Use of cerium compounds as initiators for dual-cure curing, and coating compositions comprising cerium compounds.

The present invention relates to the use of cerium compounds as initiators for dual-cure curing and to coating compositions comprising cerium compounds.

Mixtures of cerium salts and polymerization inhibitors are known systems for stabilizing ethylenically unsaturated compounds against unwanted polymerization, from U.S. Pat. No. 4,542,231 for example.

U.S. Pat. No. 3,755,234 describes the graft polymerization and block polymerization of polyvinyl alcohols in the presence of tetravalent cerium compounds. The polymerization is induced thermally and proceeds at elevated temperatures of 40-65° C.

Solvents disclosed for the cerium compounds are acidic aqueous solutions, the aim being to carry out the polymerization at a pH below 6.0, preferably below 3.0. Light-induced polymerization is not disclosed.

WO 94/24207 describes the graft polymerizing of ethylenically unsaturated compounds onto compounds comprising active hydrogen using peroxides as free-radical polymerization catalysts, which are activated by metal ions, such as, for example, Ce⁴⁺ or Ce³⁺, among others. A combination of peroxide and heavy metal ions, cerium salts among others, for initiating a graft polymerization is also disclosed in DE-A1198 06 745.

Here the cerium compound functions not as a polymerization initiator but instead as an activator for the actual catalyst, the peroxide.

R. K. Das, D. Basu, and A. Banerjee describe in Journal of Applied Polymer Science, 1999, 72, 135-140 the influence of light exposure on the graft polymerization of methyl methacrylate (MMA) onto viscose. Accordingly exposure to radiation reinforces the grafting of MMA onto viscose as a result of the presence of a Ce⁴⁺/Ti³⁺ system or Ce⁴⁺ in acidic solution, whereas no influence of radiation exposure is evidenced on the formation of polymethyl methacrylate.

Banerjee et al., therefore, do not recognize the suitability of cerium compounds for polymerization.

J. Dong, J. Yang, K. Qiu, and X. Feng described in Chinese Journal of Polymer Science, 1992, 10, 169-175 the influence of UV light on the polymerization of methyl acrylate with Ce(IV) ions in acidic and aqueous solution.

A disadvantage of all of the disclosures described above is that acid cannot be used as a solubilizer for the cerium compounds in coatings, since it impairs weather resistance and heat stability, as described for example in U.S. Pat. No. 3,755,234, column 2 line 57 to column 3 line 15. The addition of water leads to phase separation in organic coating compositions, so that the cerium which acts as initiator accumulates in the aqueous phase instead of in the organic phase, where it is supposed to start initiation; or leads to emulsions which make the coating compositions turbid.

It was an object of the present invention to provide dually curable coating compositions having improved properties.

This object has been achieved by means of coating compositions comprising—at least one cerium(IV) compound, either
at least one compound A having at least one isocyanate-reactive group and at least one free-radically polymerizable unsaturated group and at least one isocyanato-functional compound B, or
at least one compound C having at least one isocyanate group and at least one free-radically polymerizable unsaturated group and
at least one compound D having at least one isocyanate-reactive group, and additionally
if appropriate at least one photoinitiator,
if appropriate at least one solvent,
if appropriate at least one free-radically polymerizable monomer,
if appropriate at least one polyfunctional polymerizable compound, and
if appropriate further, typical coatings additives.

The term “dual cure” or “multi-cure” refers in the context of this specification to a curing process which takes place by way of two or more than two mechanisms, respectively, these mechanisms being selected, for example, from radiation curing, moisture curing, chemical curing, oxidative curing and/or thermal curing, preferably from radiation curing, moisture curing, chemical curing and/or thermal curing, more preferably from radiation curing, chemical curing and/or thermal curing, and with very particular preference from radiation curing and chemical curing.

In one preferred embodiment of the invention said chemical curing comprises, at least in part, reactions between isocyanate groups and isocyanate-reactive groups. Also conceivable, however, are the reactions between epoxides and groups that are reactive toward epoxide groups, examples being amino or hydroxyl groups, or the molecular enlargement reaction of amino resins, in other words the reaction between amino-functional compounds and aldehydes.

Radiation curing as referred to in this specification is defined as the polymerization of polymerizable compounds as a consequence of electromagnetic and/or particulate radiation, preferably UV light in the wavelength range λ from 200 to 700 nm and/or electron beams in the range from 150 to 300 keV, and more preferably with a radiation dose of at least 80, preferably 80 to 3000 mJ/cm².

In accordance with the invention cerium(IV) compounds are used to initiate a free-radical polymerization.

Cerium(IV) compounds as referred to in this invention are compounds which comprise at least one Ce⁴⁺ cation with any desired counterions.

Suitable counterions include F⁻, Cl⁻, ClO⁻, ClO₃⁻, ClO₄⁻, Br⁻, I⁻, IO₃⁻, CN⁻, OCN⁻, SCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, dithiocarbamate, salicylate, (OCₚH₂ₚ₊₁)⁻, (CₚH₂ₚ₋₁O₂)⁻, (Cₚ₊₁H₂ₚ₋₃O₂)⁻, and (Cₚ₊₁H₂ₚ₋₂O₄)²⁻, where p stands for the numbers 1 to 20, methanesulfonate (CH₃SO₃⁻), trifluoromethanesulfonate (CF₃SO₃⁻), toluenesulfonate (CH₃C₆H₄SO₃⁻), benzenesulfonate (C₆H₅SO₃⁻), hydroxide (OH⁻), anions of aromatic acids such as benzoic acid, phthalic acid, and the like, and 1,3-dicarbonyl compounds.

Additionally mention may be made of carboxylates: in particular, of formate, acetate, propionate, hexanoate, and 2-ethylhexanoate, and also of oxalate, acetylacetonate, acrylate, and methacrylate, preferably formate, acetate, propionate, oxalate, acetylacetonate, acrylate, and methacrylate.

These salts may also be in the form of hydrates, which are equally suitable.

Preferred cerium(IV) compounds are ammonium hexanitratocerate(IV) (cerium(IV) ammonium nitrate, (NH₄)₂[Ce(NO₃)₆]), sodium hexanitratocerate(IV) (Na₂[Ce(NO₃)₆]), potassium hexanitratocerate(IV) (K₂[Ce(NO₃)₆]), cerium(IV) ammonium sulfate (Ce(NH₄)₂(NO₃)₆)), cerium(IV) hydroxide, cerium(IV) isopropoxide/isopropanol complex, cerium(IV) oxide (CeO₂), and cerium(IV) sulfate (Ce(SO₄)₂).

It will be appreciated that it is also possible to use cerium compounds in a lower oxidation state than +4 and to convert them into a cerium(IV) compound within the coating composition with the aid of an oxidizing agent; in particular cerium(III) compounds.

Preferred cerium(III) compounds are cerium(III) acetate, cerium(III) acetate hydrate, cerium(III) acetylacetonate, cerium(III) acetylacetonate hydrate, cerium(III) bromide, cerium(III) carbonate, cerium(III) carbonate hydrate, cerium(III) chloride (CeCl₃), cerium(III) chloride heptahydrate, cerium(III) ethylhexanoate and its solutions or dispersions in mineral oil or naphtha (Octa Soliogen Cerium® 6 and 10 from Borcherts, Monheim, Germany, CAS number [58797-01-4]), cerium(III) fluoride, cerium(III) nitrate (Ce(NO₃)₃), cerium(III) nitrate hexahydrate, cerium(III) oxalate, cerium(III) sulfate, cerium(III) sulfate octahydrate, cerium(III) oxide or cerium(III) acrylate.

Suitable oxidizing agents in this context, in accordance with the invention, are those which in their turn do not trigger polymerization, i.e., are not free-radical initiators.

It is preferred, however, to employ the cerium compounds as cerium(IV) compounds.

The cerium compounds can also be employed as complexes, complexed for example with amine-, sulfur-, nitrogen-, phosphorus- and/or oxygen-containing ligands, or as cyclopentadienyl complexes. Examples of ligands are mercaptans, sulfides, primary, secondary or tertiary amines, primary, secondary or tertiary phosphines, alcohols, and ethers, and also cyclopentadiene, benzene, furan, pyrrole, pyridine, and thiophene, and also derivatives thereof, and also complexing agents such as ethanolamines, ethylenediaminetetraacetate, ethylenediaminetriacetate, nitrilotriacetic acid, and the like.

The purity of the cerium salts employed is not critical to the invention; in general it is sufficient for the salt to have technical purity of 80% or more for example, preferably at least 90%, more preferably at least 95%, with very particular preference at least 98%, and in particular at least 99%. It will be appreciated that the salts can also be used in states of higher or lower purity.

It will be appreciated that mixtures of two or more cerium salts can also be used, such as of two or three cerium salts, for example, although the use of one cerium salt is preferred.

The cerium compound is comprised generally in amounts up to 2% by weight (based on the coating composition as a whole), preferably up to 1.5%, more preferably up to 1.0%, and very preferably up to 0.5% by weight.

Typically the cerium compound is comprised in amounts of at least 0.01% by weight, preferably at least 0.05%, more preferably at least 0.1%, and very preferably at least 0.2% by weight.

In a first embodiment in accordance with the invention the coating compositions comprise at least one compound A having at least one isocyanate-reactive group and at least one free-radically polymerizable unsaturated group together with another compound B which has at least one isocyanate group.

In another embodiment the coating compositions of the invention comprise at least one compound C having at least one isocyanate group and at least one free-radically polymerizable unsaturated group and additionally at least one compound D having at least one isocyanate-reactive group.

Examples of possible isocyanate-reactive groups include —OH, —SH, —NH₂, and —NHR³, where R³ can be C₁-C₄ alkyl, i.e., methyl, ethyl, isopropyl, n-propyl, n-butyl, isobutyl, sec-butyl or tert-butyl.

Polymerizable groups can be those which have unsaturated bonds, preferably carbon-carbon double bonds, more preferably α,β-ethylenically unsaturated carbonyl compounds.

Free-radically polymerizable groups are, for example, isolated ethylenically unsaturated groups, conjugated unsaturated groups, vinylaromatic groups, vinyl- and vinylidene-chloridic groups, N-vinylamides, vinylpyrrolidones, vinyllactams, vinyl esters, (meth)acrylic esters or acrylonitriles.

Compounds A having at least one isocyanate-reactive group and at least one free-radically polymerizable unsaturated group have at least one, preferably 1 to 10, more preferably 1 to 6, and very preferably 1 to 4 isocyanate-reactive groups and at the same time at least one, preferably 1 to 10, more preferably 1 to 6, and very preferably 1 to 4 free-radically polymerizable unsaturated groups.

Suitable compounds A may be, for example, monoesters of α,β-unsaturated carboxylic acids, such as acrylic acid, methacrylic acid, crotonic acid, itaconic acid, fumaric acid, maleic acid, acrylamidoglycolic acid, methacrylamidoglycolic acid, or vinyl ethers, with diols or polyols which have preferably 2 to 20 carbon atoms and at least two hydroxyl groups, such as ethylene glycol, diethylene glycol, triethylene glycol, propylene 1,2-glycol, propylene 1,3-glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, 1,6-hexanediol, 2-methyl-1,5-pentanediol, 2-ethyl-1,4-butanediol, 1,4-dimethylolcyclohexane, glycerol, trimethylolethane, trimethylolpropane, trimethylolbutane, pentaerythritol, ditrimethylolpropane, erythritol, sorbitol, polyTHF having a molar weight between 162 and 2000, poly-1,3-propanediol having a molar weight between 134 and 1178 or polyethylene glycol having a molar weight between 238 and 898. Additionally it is also possible to use esters or amides of (meth)acrylic acid with amino alcohols, examples being 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine, or vinylacetic acid.

Additionally suitable as well are unsaturated polyetherols or polyesterols or polyacrylate polyols having an average OH functionality of 2 to 10.

Examples of amides of ethylenically unsaturated carboxylic acids with amino alcohols are hydroxyalkyl(meth)acrylamides such as N-hydroxymethylacrylamide, N-hydroxymethylmethacrylamide, N-hydroxyethylacrylamide, N-hydroxyethylmethacrylamide, 5-hydroxy-3-oxapentyl(meth)acrylamide, N-hydroxyalkylcrotonamides such as N-hydroxymethylcrotonamide or N-hydroxyalkylmaleimides such as N-hydroxyethylmaleimide.

The compounds in question may additionally be products of the reaction of the above-recited α,β-unsaturated carboxylic acids with epoxides, preferably epoxides having at least twofold functionalization.

The compounds in question may be, for example, the products of reaction of (meth)acrylic acid with epoxides or with aromatic or aliphatic glycidyl ethers, preferably the products of reaction of (meth)acrylic acid with bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]) and cresol-based epoxy novolaks (CAS No. [37382-79-9]), and additionally 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), and diglycidyl ethers of polypropylene glycol (α,ω)-bis(2,3-epoxypropoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

Preference is given to using 2-hydroxyethyl(meth)acrylate, 2- or 3-hydroxypropyl(meth)acrylate, 1,4-butanediol mono(meth)acrylate, neopentyl glycol mono(meth)acrylate, glycerol mono- and di(meth)acrylate, trimethylolpropane mono- and di(meth)acrylate, pentaerythritol mono-, di-, and tri(meth)acrylate, and 4-hydroxybutyl vinyl ether, 2-aminoethyl(meth)acrylate, 2-aminopropyl(meth)acrylate, 3-aminopropyl(meth)acrylate, 4-aminobutyl(meth)acrylate, 6-aminohexyl(meth)acrylate, 2-thioethyl(meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide, and the reaction products of (meth)acrylic acid with bisphenol A diglycidyl ether, bisphenol F diglycidyl ether, 1,4-butanediol diglycidyl ether, 1,6-hexanediol diglycidyl ether, trimethylolpropane triglycidyl ether or pentaerythritol tetraglycidyl ether.

Particular preference is given to 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl methacrylate, and the reaction product of acrylic acid with bisphenol A diglycidyl ether or 1,4-butanediol diglycidyl ether.

Examples of suitable isocyanato-functional compounds B include aliphatic, aromatic, and cycloaliphatic di- and polyisocyanates having an NCO functionality of at least 1.8, preferably 1.8 to 5, and more preferably 2 to 4, and also their isocyanurates, biurets, allophanates, and uretdiones.

The diisocyanates are preferably isocyanates having 4 to 20 carbon atoms. Examples of typical diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and also aromatic diisocyanates such as tolylene 2,4- or 2,6-diisocyanate and their isomer mixtures, m- or p-xylylene diisocyanate, 2,4′- or 4,4′-diisocyanatodiphenylmethane and their isomer mixtures, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Preference is given to hexamethylene diisocyanate, 1,3-bis(isocyanatomethyl)cyclohexane, isophorone diisocyanate, and di(isocyanatocyclohexyl)methane.

Suitable polyisocyanates include polyisocyanates containing isocyanurate groups, uretdione diisocyanates, polyisocyanates containing biuret groups, polyisocyanates containing urethane or allophanate groups, polyisocyanates containing oxadiazinetrione groups, uretonimine-modified polyisocyanates of linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

The di- and polyisocyanates which can be used preferably have an isocyanate group content (calculated as NCO, molecular weight=42) of 10% to 60% by weight based on the di- and polyisocyanate (mixture), preferably 15% to 60% by weight, and more preferably 20% to 55% by weight.

Preference is given to aliphatic and/or cycloaliphatic di- and polyisocyanates, examples being the abovementioned aliphatic and/or cycloaliphatic diisocyanates, or mixtures thereof.

Preference extends to
1. isocyanurate group-containing polyisocyanates of aromatic, aliphatic and/or cycloaliphatic diisocyanates. Particular preference here goes to the corresponding aliphatic and/or cycloaliphatic isocyanato-isocyanurates and, in particular, to those based on hexamethylene diisocyanate and isophorone diisocyanate. The isocyanurates present are, in particular, tris-isocyanatoalkyl and tris-isocyanatocycloalkyl isocyanurates, which represent cyclic trimers of the diisocyanates, or are mixtures with their higher homologs containing more than one isocyanurate ring. The isocyanato-isocyanurates generally have an NCO content of 10% to 30% by weight, in particular 15% to 25% by weight, and an average NCO functionality of 3 to 4.5.
2. Uretdione diisocyanates having aromatically, aliphatically and/or cycloaliphatically attached isocyanate groups, preferably aliphatically and/or cycloaliphatically attached groups, and especially those derived from hexamethylene diisocyanate or isophorone diisocyanate. Uretdione diisocyanates are cyclic dimerization products of diisocyanates.
   The uretdione diisocyanates can be used in the preparations of the invention as a sole component or in a mixture with other polyisocyanates, especially those specified under 1).
3. Polyisocyanates containing biuret groups and aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 3 to 4.5.
4. Polyisocyanates containing urethane and/or allophanate groups and aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with polyhydric alcohols such as, for example, trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates containing urethane and/or allophanate groups generally have an NCO content of 12% to 20% by weight and an average NCO functionality of 2.5 to 3.
5. Polyisocyanates comprising oxadiazinetrione groups, derived preferably from hexamethylene diisocyanate or isophorone diisocyanate. Polyisocyanates of this kind comprising oxadiazinetrione groups are preparable from diisocyanate and carbon dioxide.
6. Uretonimine-modified polyisocyanates.

The polyisocyanates 1) to 6) can be used in a mixture, including if appropriate a mixture with diisocyanates.

The compounds C having at least one isocyanate group and at least one free-radically polymerizable unsaturated group can be compounds which have at least one, preferably 1 to 10, more preferably 1 to 6 and very preferably 1 to 4 isocyanate groups, and at least one, preferably 1 to 10, more preferably 1 to 6, and very preferably 1 to 4 free-radically polymerizable unsaturated groups.

They may be, for example, products of reaction of the abovementioned compounds A with compounds B, the stoichiometric ratio of A to B being selected such that free isocyanate groups still remain in the reaction product, in other words as a consequence of a substoichiometric reaction between isocyanate groups in A with isocyanate-reactive groups in B. If appropriate the compounds B may also have further free-radically polymerizable unsaturated groups.

With particular preference the compounds in question may be those described in WO 00/39183, page 4 line 14 to page 16 line 40, expressly incorporated hereby as part of the present disclosure content, and with very particular preference those compounds as described in WO 00/39183 in Example 1 and Table 1, likewise incorporated by reference.

Compounds D are those having at least one isocyanate-reactive group, preferably having 1 to 10, more preferably 1 to 6, and very preferably 1 to 4 isocyanate-reactive groups. If appropriate the compounds D may also have further free-radically polymerizable unsaturated groups.

The compounds D may for example be at least dihydric polyalcohols, of the kind listed below.

With preference they are the compounds A listed above, and more preferably 2-hydroxyethyl(meth)acrylate, 2- or 3-hydroxypropyl(meth)acrylate, 1,4-butanediol mono(meth)acrylate, neopentyl glycol mono(meth)acrylate, glycerol mono- and di(meth)acrylate, trimethylolpropane mono- and di(meth)acrylate, pentaerythritol mono- di, and tri(meth)acrylate, and 4-hydroxybutyl vinyl ether, 2-aminoethyl(meth)acrylate, 2-aminopropyl(meth)acrylate, 3-aminopropyl(meth)acrylate, 4-aminobutyl(meth)acrylate, 6-aminohexyl(meth)acrylate, 2-thioethyl(meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide, and the reaction products of (meth)acrylic acid with bisphenol A diglycidyl ether, bisphenol F diglycidyl ether, 1,4-butanediol diglycidyl ether, 1,6-hexanediol diglycidyl ether, trimethylolpropane triglycidyl ether or pentaerythritol tetraglycidyl ether.

Very particular preference is given to 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl methacrylate, and the reaction product of acrylic acid with bisphenol A diglycidyl ether or 1,4-butanediol diglycidyl ether.

In the coating composition of the invention the ratio of the compounds A: B and C: D, respectively, is to be selected such that, in the course of curing, the isocyanate groups in particular have undergone predominant reaction, i.e., reaction to an extent of more than 50%, preferably more than 66%, more preferably more than 75%, very preferably more than 85%, in particular more than 90%, and especially more than 95%.

This can be achieved, for example, by selecting a stoichiometry of isocyanate groups to isocyanate-reactive groups in the range of 1:0.8-2.0, preferably 1:0.9-1.5, and more preferably 1:1.0-1.2.

However, higher or lower molar ratios may also be rational: for example, a higher fraction of isocyanate groups if the coating is to be additionally moisture-curable.

Optionally the cerium compounds can be used in a mixture with other photoinitiators. These may be, for example, photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Ed.), SITA Technology Ltd, London. In one preferred embodiment of the invention there is at least one further photoinitiator present in addition to the at least one cerium compound.

Suitable examples include mono- or bisacylphosphine oxides, as described in, for example, EP-A 7 508, EP-A 57 474, DE-A 196 18 720, EP-A 495 751 or EP-A 615 980 examples being 2,4,6-trimethylbenzoyldiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from Ciba Spezialitätenchemie), benzophenones, hydroxyacetophenones, phenylglyoxylic acid and its derivatives, or mixtures of these photoinitiators. Examples that may be mentioned include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindol, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracen-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzyl ketals, such as benzyl dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, and 2-amylanthraquinone, and 2,3-butanedione.

Also suitable are non-yellowing or low-yellowing photoinitiators of the phenylglyoxalic ester type, as described in DE-A 198 26 712, DE-A 199 13 353 or WO 98/33761.

Preferred among these photoinitiators are 2,4,6-trimethylbenzoyldiphenylphosphine oxide, ethyl 2,4,6-trimethylbenzoylphenylphosphinate, bis(2,4,6-trimethylbenzoyl)-phenylphosphine oxide, benzophenone, 1-benzoylcyclohexan-1-ol, 2-hydroxy-2,2-dimethylacetophenone and 2,2-dimethoxy-2-phenylacetophenone.

Optionally it is possible for at least one solvent to be used in the coating compositions of the invention. Suitable solvents are those in which the cerium compound in question is soluble.

Examples of such solvents are water, (meth) acrylic acid (esters), acetone, acetylacetone, ethyl acetoacetate, lower alcohols, such as methanol, ethanol, iso-propanol, n-propanol, n-butanol, isobutanol, sec-butanol, tert-butanol, 2-ethylhexyl alcohol, ethylene glycol, diethylene glycol, ethylene glycol dimethyl ether, ethylene glycol diethyl ether, ethylene glycol di-n-butyl ether, diethylene glycol, diethylene glycol dimethyl ether, diethylene glycol diethyl ether, diethylene glycol di-n-butyl ether, polyethylene glycols having a molar mass up to 898, polypropylene glycols having a molar mass of 134 to 308, lower carboxylic acids, such as formic acid, acetic acid or propionic acid, THF, dioxane, acetonitrile, propionitrile, dimethylformamide, dimethyl sulfoxide, sulfolane, dimethyl carbonate, diethyl carbonate, di-n-butyl carbonate, 1,2-ethylenecarbonate, 1,2-propylenecarbonate or 1,3-propylenecarbonate.

Preferred solvents are those in which the cerium compound has a solubility of at least 0.5%, preferably at least 1%, more preferably at least 2%, very preferably at least 5%, and in particular at least 10% by weight and which in turn are miscible with the coating composition in the proportion used.

Very particular preference is given to water, methanol, ethanol, isopropanol, n-propanol, n-butanol, ethylene glycol, diethylene glycol, ethylene glycol dimethyl ether, THF, dioxane, acetonitrile, propionitrile, dimethylformamide, dimethyl sulfoxide, sulfolane, dimethyl carbonate, diethyl carbonate, 1,2-ethylenecarbonate, and 1,2-propylenecarbonate.

Especial preference is given to water, methanol, ethanol, isopropanol, n-propanol, n-butanol, ethylene glycol, THF, dioxane, acetonitrile, dimethylformamide, and dimethyl sulfoxide.

Free-radical polymerizable monomers are, for example, reactive diluents are, for example, esters of (meth)acrylic acid with alcohols having 1 to 20 carbon atoms, examples being methyl(meth)acrylate, ethyl(meth)acrylate, butyl(meth)acrylate, 2-ethylhexyl(meth)acrylate, 2-hydroxyethyl acrylate, 4-hydroxybutyl acrylate, dihydrodicyclopentadienyl acrylate, vinylaromatic compounds, such as styrene, divinylbenzene, α,β-unsaturated nitriles, such as acrylonitrile, methacrylonitrile, α,β-unsaturated aldehydes, such as acrolein, methacrolein, vinyl esters, such as vinyl acetate, vinyl propionate, halogenated ethylenically unsaturated compounds, such as vinyl chloride, vinylidene chloride, conjugated unsaturated compounds, such as butadiene, isoprene, chloroprene, monounsaturated compounds, such as ethylene, propylene, 1-butene, 2-butene, isobutene, cyclic monounsaturated compounds, such as cyclopentene, cyclohexene, cyclododecene, N-vinylformamide, allylacetic acid, vinylacetic acid, monoethylenically unsaturated carboxylic acids having 3 to 8 carbon atoms, and their water-soluble alkali metal salts, alkaline earth metal salts or ammonium salts, such as, for example, acrylic acid, methacrylic acid, dimethylacrylic acid, ethacrylic acid, maleic acid, citraconic acid, methylenemalonic acid, crotonic acid, fumaric acid, mesaconic acid, and itaconic acid, maleic acid, N-vinylpyrrolidone, N-vinyllactams, such as N-vinylcaprolactam, N-vinyl-N-alkylcarboxamides or N-vinyl-carboxamides, such as N-vinylacetamide, N-vinyl-N-methylformamide, and N-vinyl-N-methylacetamide, or vinyl ethers, such as methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, and 4-hydroxybutyl vinyl ether, for example, and also mixtures thereof.

(Meth)acrylic acid in this specification stands for methacrylic acid and acrylic acid, preferably for acrylic acid.

Polyfunctional polymerizable compounds are preferably polyfunctional (meth)acrylates which carry more than 1, preferably 2-10, more preferably 2-6, very preferably 2-4, and in particular 2-3 (meth)acrylate groups, preferably acrylate groups.

These may be, for example, esters of (meth)acrylic acid with polyalcohols having a corresponding functionality of at least two.

Examples of suitable such polyalcohols are at least dihydric polyols, polyetherols or polyesterols, or polyacrylate polyols, having an average OH functionality of at least 2, preferably 3 to 10.

Examples of polyfunctional polymerizable compounds are ethylene glycol diacrylate, 1,2-propanediol diacrylate, 1,3-propanediol diacrylate, 1,4-butanediol diacrylate, 1,3-butanediol diacrylate, 1,5-pentanediol diacrylate, 1,6-hexanediol diacrylate, 1,8-octanediol diacrylate, neopentyl glycol diacrylate, 1,1-, 1,2-, 1,3-, and 1,4-cyclohexanedimethanol diacrylate, 1,2-, 1,3- or 1,4-cyclohexanediol diacrylate, trimethylolpropane triacrylate, ditrimethylolpropane pentaacrylate or hexaacrylate pentaerythritol triacrylate or tetraacrylate, glycerol diacrylate or triacrylate, and also diacrylates and polyacrylates of sugar alcohols, such as of sorbitol, mannitol, diglycerol, threitol, erythritol, adonitol (ribitol), arabitol (Iyxitol), xylit, dulcitol (galactitol), maltitol or isomalt, for example, or of polyester polyols, polyetherols, poly-THF having a molar mass between 162 and 2000, poly-1,3-propanediol having a molar mass between 134 and 1178, polyethylene glycol having a molar mass between 106 and 898, and also epoxy(meth)acrylates, urethane (meth)acrylates or polycarbonate (meth)acrylates.

Further examples of (meth)acrylates of compounds of the formula (Ia) to (Ic), 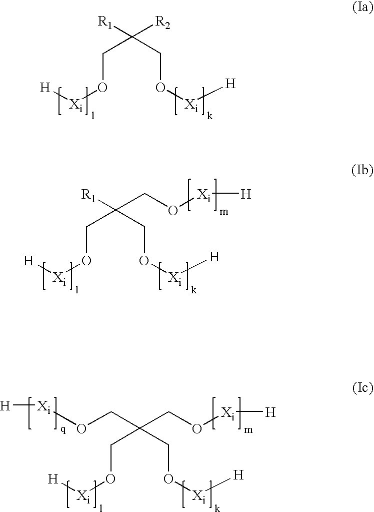 in which
R¹ and R² each independently are hydrogen or unsubstituted or aryl-, alkyl-, aryloxy-, alkyloxy-, heteroatom- and/or heterocycle-substituted C₁-C₁₈ alkyl,
k, l, m, and q each independently are an integer from 1 to 10, preferably 1 to 5, and more preferably 1 to 3, and
each Xᵢ for i=1 to k, 1 to l, 1 to m, and 1 to q can be selected independently of the others from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O— and —CH(CH₃)—CH₂—O—, and more preferably —CH₂—CH₂—O—,
in which Ph is phenyl and Vin is vinyl.

In these formulae unsubstituted or aryl-, alkyl-, aryloxy-, alkyloxy-, heteroatom- and/or heterocycle-substituted C₁-C₁₈ alkyl is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, preferably methyl, ethyl or n-propyl, very preferably methyl or ethyl.

The compounds in question are preferably (meth)acrylates of singly to vigintuply and more preferably triply to decuply ethoxylated, propoxylated or mixedly ethoxylated and propoxylated, and especially exclusively ethoxylated, neopentyl glycol, trimethylolpropane, trimethylolethane or pentaerythritol.

Preferred polyfunctional polymerizable compounds are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythritol tetraacrylate, polyester polyol acrylates, polyetherol acrylates, and triacrylate of singly to vigintuply ethoxylated trimethylolpropane.

Particularly preferred polyfunctional polymerizable compounds are 1,4-butanediol diacrylate, 1,6-hexanediol diacrylate, trimethylolpropane triacrylate, pentaerythritol tetraacrylate, and triacrylate of singly to vigintupy ethoxylated trimethylolpropane.

Polyester polyols are known for example from Ullmanns Encyklopädie der technischen Chemie, 4th edition, Volume 19, pp. 62 to 65. Preference is given to using polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides, or dialkyl esters, examples being C₁-C₄ alkyl esters, preferably methyl, ethyl or n-butyl esters, of the stated acids. Preference is given to dicarboxylic acids of the general formula HOOC—(CH₂)_{y}—COOH, where y is a number from 1 to 20, preferably an even number from 2 to 20, and particular preference to succinic acid, adipic acid, sebacic acid, and dodecanedicarboxylic acid.

Polyhydric alcohols suitable for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, poly-THF having a molar mass between 162 and 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxy-cyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if appropriate may have been alkoxylated as described above.

Preference is given to alcohols of the general formula HO—(CH₂)ₙ—OH, where x is a number from 1 to 20, preferably an even number from 2 to 20. Preferred alcohols are ethylene glycol, butane-1,4-diol, hexane-1,6-diol, octane-1,8-diol, and dodecane-1,12-diol. Additionally preferred is neopentyl glycol.

Further suitable alcohols include polycarbonate diols, of the kind obtainable, for example, by reacting phosgene with an excess of the low molecular mass alcohols specified as synthesis components for the polyester polyols.

Also suitable are lactone-based polyesterdiols, which are homopolymers or copolymers of lactones, preferably hydroxy-terminal adducts of lactones with suitable difunctional starter molecules. Suitable lactones are preferably those derived from compounds of the general formula HO—(CH₂)_{z}—COOH, where z is a number from 1 to 20 and where one hydrogen atom in a methylene unit may also be substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Suitable starter components are, for example, the low molecular mass dihydric alcohols specified above as a synthesis component for the polyester polyols. The corresponding polymers of ε-caprolactone are particularly preferred. Lower polyester diols or polyether diols as well can be used as starter for preparing the lactone polymers. In lieu of the polymers of lactones it is also possible to use the corresponding, chemically equivalent polycondensates of the hydroxycarboxylic acids corresponding to the lactones.

The polyfunctional polymerizable compound may further comprise urethane (meth)acrylates, epoxy (meth)acrylates or carbonate (meth)acrylates.

Urethane (meth)acrylates for example are obtainable by reacting polyisocyanates with hydroxyalkyl (meth)acrylates or hydroxyalkyl vinyl ethers and, if appropriate, chain extenders such as diols, polyols, diamines, polyamines or dithiols or polythiols. Urethane (meth)acrylates which can be dispersed in water without addition of emulsifiers additionally comprise ionic and/or nonionic hydrophilic groups, which are introduced into the urethane by means, for example, of synthesis components such as hydroxycarboxylic acids.

The polyurethanes which can be used comprise as synthesis components substantially:
(a) at least one organic aliphatic, aromatic or cycloaliphatic di- or polyisocyanate,
(b) at least one compound having at least one isocyanate-reactive group and at least one free-radically polymerizable unsaturated group, and
(c) if appropriate at least one compound having at least two isocyanate-reactive groups.

Compounds suitable as component (a) are those as listed above as compounds B.

Compounds suitable as component (b) are those which carry at least one isocyanate-reactive group and at least one free-radically polymerizable group.

Isocyanate-reactive groups may be, for example, —OH, —SH, —NH₂, and —NHR³, where R³ is hydrogen or an alkyl group comprising 1 to 4 carbon atoms, such as methyl, ethyl, n-propyl, isopropyl, n-butyl, isobutyl, sec-butyl or tert-butyl, for example.

Components (b) may be compounds of the kind listed above as compounds A.

Compounds suitable as component (c) are those having at least two isocyanate-reactive groups, examples being —OH, —SH, —NH₂ or —NHR⁴, in which R⁴ therein may, independently at each occurrence be hydrogen, methyl, ethyl, isopropyl, n-propyl, n-butyl, isobutyl, sec-butyl or tert-butyl.

These are preferably diols or polyols, such as hydrocarbon diols having 2 to 20 carbon atoms, examples being ethylene glycol, 1,2-propanediol, 1,3-propanediol, 1,1-dimethylethane-1,2-diol, 1,6-hexanediol, 1,10-decanediol, bis(4-hydroxycyclohexane)-isopropylidene, tetramethylcyclobutanediol, 1,2-, 1,3- or 1,4-cyclohexanediol, cyclo-octanediol, norbornanediol, pinanediol, decalindiol, etc., their esters with short-chain dicarboxylic acids, such as adipic acid, cyclohexanedicarboxylic acid, their carbonates, prepared by reacting the diols with phosgene or by transesterification with dialkyl or diaryl carbonates, or aliphatic diamines, such as methylene-, and isopropylidenebis-(cyclohexylamine), piperazine, 1,2-, 1,3- or 1,4-diaminocyclohexane, 1,2-, 1,3- or 1,4-cyclohexanebis(methylamine), etc., dithiols or polyfunctional alcohols, secondary or primary amino alcohols, such as ethanolamine, diethanolamine, monopropanolamine, dipropanolamine, etc. or thioalcohols, such as thioethylene glycol.

Additionally conceivable are diethylene glycol, triethylene glycol, dipropylene glycol, tripropylene glycol, neopentyl glycol, pentaerythritol, 1,2- and 1,4-butanediol, 1,5-pentanediol, 2-methyl-1,5-pentanediol, 2-ethyl-1,4-butanediol, 1,2-, 1,3-, and 1,4-dimethylolcyclohexane, 2,2-bis(4-hydroxycyclohexyl)propane, glycerol, trimethylolethane, trimethylolpropane, trimethylolbutane, dipentaerythritol, ditrimethylolpropane, erythritol, and sorbitol, 2-aminoethanol, 3-amino-1-propanol, 1-amino-2-propanol or 2-(2-aminoethoxy)ethanol, bisphenol A, or butanetriol.

Also suitable, furthermore, are unsaturated polyetherols or polyesterols or polyacrylate polyols having an average OH functionality of 2 to 10, and also polyamines, such as polyethyleneimine, or polymers containing free amine groups, of poly-N-vinyl-formamide, for example.

Particularly suitable here are the cycloaliphatic diols, such as bis(4-hydroxy-cyclohexane)isopropylidene, tetramethylcyclobutanediol, 1,2-, 1,3- or 1,4-cyclo-hexanediol, cyclooctanediol or norbornanediol.

The polyurethanes which can be used are obtained by reacting components (a), (b), and (c) with one another.

The molar composition (a):(b):(c) here per 3 mol of reactive isocyanate groups
(a) can in general be selected arbitrarily, and is preferably as follows:
(b) 1.5-3.0, preferably 2.0-2.9, more preferably 2.0-2.5, and in particular 2.0-2.3 mol of isocyanate-reactive groups, and
(c) 0-1.5, preferably 0.1-1.0, more preferably 0.5-1.0, and in particular 0.7-1.0 mol of isocyanate-reactive groups.

When polyurethanes are used in aqueous systems it is preferable for substantially all of the isocyanate groups present to have undergone reaction.

The formation of the adduct from isocyanato-functional compound and the compound comprising isocyanate-reactive groups takes place in general by mixing the components in arbitrary order, if appropriate at elevated temperature. Preferably in this case the compound comprising isocyanate-reactive groups is added to the isocyanato-functional compound, preferably in two or more steps.

With particular preference the isocyanato-functional compound is introduced as an initial charge and the compounds comprising isocyanate-reactive groups are added. In particular the isocyanato-functional compound (a) is introduced as an initial charge and subsequently (b) is added. After that it is possible if appropriate for further compounds desired to be added.

In general the reaction is carried out at temperatures between 5 and 100° C., preferably between 20 to 90° C. and more preferably between 40 and 80° C., and in particular between 60 and 80° C.

It is preferred in this context to operate under water-free conditions. Water-free means here that the water content of the reaction system is not more than 5% by weight, preferably not more than 3% by weight, and more preferably not more than 1% by weight.

The reaction can be carried out in the presence of at least one suitable inert gas, examples being nitrogen, argon, helium, carbon dioxide or the like, although this is generally not necessary.

The reaction can also be carried out in the presence of an inert solvent, an example being acetone, isobutyl methyl ketone, toluene, xylene, butyl acetate or ethoxyethyl acetate.

The urethane (meth)acrylates preferably have a number-average molar weight Mₙ of 500 to 20 000, in particular of 500 to 10 000, with particular preference 600 to 3000 g/mol (as determined by means of gel permeation chromatography using tetrahydrofuran and polystyrene as standard).

The urethane (meth)acrylates preferably have a (meth)acrylic group content of 1 to 5, more preferably of 2 to 4, mol per 1000 g of urethane (meth)acrylate.

Epoxy (meth)acrylates are obtainable by reacting epoxides with (meth)acrylic acid. Examples of suitable epoxides include epoxidized olefins, aromatic glycidyl ethers or aliphatic glycidyl ethers, preferably those from aromatic or aliphatic glycidyl ethers.

Examples of possible epoxidized olefins include ethylene oxide, propylene oxide, iso-butylene oxide, 1-butene oxide, 2-butene oxide, vinyloxirane, styrene oxide or epichlorohydrin, preference being given to ethylene oxide, propylene oxide, iso-butylene oxide, vinyloxirane, styrene oxide or epichlorohydrin, particular preference to ethylene oxide, propylene oxide or epichlorohydrin, and very particular preference to ethylene oxide and epichlorohydrin.

Examples of aromatic glycidyl ethers include bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers are 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-374]), and diglycidyl ethers of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

The epoxy (meth)acrylates and epoxy vinyl ethers preferably have a number-average molar weight Mₙ of 200 to 20 000, more preferably of 200 to 10 000 g/mol and very preferably of 250 to 3000 g/mol; the (meth)acrylic or vinyl ether group content is preferably 1 to 5, more preferably 2 to 4, per 1000 g of epoxy (meth)acrylate or vinyl ether epoxide (as determined by means of gel permeation chromatography using polystyrene as standard and tetrahydrofuran as eluent).

Carbonate (meth)acrylates comprise on average preferably 1 to 5, in particular 2 to 4, more preferably 2 to 3 (meth)acrylic groups, and very preferably 2 (meth)acrylic groups.

The number-average molecular weight Mₙ of the carbonate (meth)acrylates is preferably less than 3000 g/mol, more preferably less than 1500 g/mol, very preferably less than 800 g/mol (as determined by means of gel permeation chromatography using polystyrene as standard and tetrahydrofuran as solvent).

The carbonate (meth)acrylates are readily obtainable by transesterification of carbonic esters with polyhydric, preferably dihydric alcohols (diols, hexanediol for example) and subsequent esterification of the free OH groups with (meth)acrylic acid or else transesterification with (meth)acrylic esters, as described for example in EP-A 92 269. They are also obtainable by reaction of phosgene, urea derivatives with polyhydric, e.g., dihydric alcohols.

Vinyl ether carbonates as well are obtainable analogously, by reaction of a hydroxyalkyl vinyl ether with carbonic esters and also, if appropriate, with dihydric alcohols.

Also conceivable are (meth)acrylates or vinyl ethers of polycarbonate polyols, such as the reaction product of one of the stated diols or polyols and a carbonic ester, and also a hydroxyl-containing (meth)acrylate or vinyl ether.

Examples of suitable carbonic esters include ethylene carbonate, 1,2- or 1,3-propylene carbonate, or dimethyl, diethyl or dibutyl carbonate.

Examples of suitable hydroxyl-containing (meth)acrylates are 2-hydroxyethyl (meth)acrylate, 2- or 3-hydroxypropyl(meth)acrylate, 1,4-butanediol mono(meth)acrylate, neopentyl glycol mono(meth)acrylate, glycerol mono- and di(meth)acrylate, trimethylolpropane mono- and di(meth)acrylate, and pentaerythritol mono-, di-, and tri(meth)acrylate.

Examples of suitable hydroxyl-containing vinyl ethers are 2-hydroxyethyl vinyl ether and 4-hydroxybutyl vinyl ether.

Particularly preferred carbonate (meth)acrylates are those of the formula: 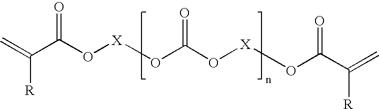
in which R is H or CH₃, X is a C₂-C₁₈ alkylene group, and n is an integer from 1 to 5, preferably 1 to 3.

R is preferably H and X is preferably C₂ to C₁₀ alkylene, 1,2-ethylene, 1,2-propylene, 1,3-propylene, 1,4-butylene or 1,6-hexylen for example, more preferably C₄ to C₈ alkylene. With very particular preference X is C₆ alkylene.

The carbonate (meth)acrylates are preferably aliphatic carbonate (meth)acrylates.

Among the polyfunctional polymerizable compounds urethane (meth)acrylates are particularly preferred.

Examples of further, typical coatings additives used may include antioxidants, stabilizers, activators (accelerants), fillers, pigments, dyes, antistats, flame retardants, thickeners, thixotropic agents, surface-active agents, viscosity modifiers, plasticizers or chelating agents.

In one preferred embodiment of the invention the coating composition comprises at least one pigment.

If a pigment comprising cerium is used, then this pigment, owing to its low solubility, which characterizes pigments, is not effective as a significant source of cerium within the meaning of this invention. The solubility of pigments is generally not more than 1 g/1000 g of application medium at 25° C.

Accelerants used for the thermal aftercure may include, for example, tin octoate, zinc octoate, dibutyltin laurate or diazabicyclo[2.2.2]octane.

In addition it is possible to add one or more thermally activatable initiators, examples being potassium peroxodisulfate, dibenzoyl peroxide, cyclohexanone peroxide, di-tert-butyl peroxide, azobisisobutyronitrile, cyclohexylsulfonyl acetyl peroxide, di-isopropyl percarbonate, tert-butyl peroctoate or benzpinacol, and also, for example, those thermally activable initiators which have a half-life at 80° C. of more than 100 hours, such as di-tert-butyl peroxide, cumene hydroperoxide, dicumyl peroxide, tert-butyl perbenzoate, silylated pinacols, available for example under the tradename ADDID 600 from Wacker commercially, or hydroxyl-containing amine N-oxides, such as 2,2,6,6-tetramethylpiperidine-N-oxyl, 4-hydroxy-2,2,6,6-tetramethylpiperidine-N-oxyl, etc.

Further examples of suitable initiators are described in “Polymer Handbook”, 2nd ed., Wiley & Sons, New York.

Suitable thickeners include, besides free-radically (co)polymerized (co)polymers, customary organic and inorganic thickeners such as hydroxymethylcellulose or bentonite.

As chelate formers it is possible to make use of, for example, ethylenediamineacetic acid and its salts and also β-diketones.

Suitable fillers comprise silicates, examples being silicates obtainable by hydrolysis of silicon tetrachloride, such as Aerosil® from Degussa, siliceous earth, talc, aluminum silicates, magnesium silicates, and calcium carbonates, etc.

Suitable stabilizers comprise typically UV absorbers such as oxanilides, triazines, and benzotriazole (the latter obtainable as Tinuvin® grades from Ciba-Spezialitätenchemie), and benzophenones. These can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are typically used in amounts of 0.1% to 5.0% by weight, based on the solid components comprised in the preparation.

The constitution of the coating compositions is generally as follows:
fraction of the at least one cerium(IV) compound as indicated above,
0.1% to 99.8%, preferably 0.5%-98%, more preferably 1%-95%, very preferably 10%-90%, and in particular 25%-85% by weight of compounds A and B or C and D, respectively
0 to 5%, preferably 0.1%-5%, more preferably 0.2%-4%, and very preferably

0.5% to 3% by weight of at least one photoinitiator,
0% to 25%, preferably 0.5%-20%, more preferably 1%-15%, and very preferably 5% to 15% by weight of at least one solvent,
0-50%, preferably 5% to 30%, more preferably 10% to 20%, and very preferably 10% to 15% by weight of at least one free-radically polymerizable monomer,
0 to 50%, preferably 0 to 30%, more preferably 5% to 30%, and very preferably 10% to 25% by weight of at least one polyfunctional polymerizable compound, and
up to 50%, preferably 1% to 50%, more preferably 5% to 30%, and very preferably 20% to 30% by weight of further, typical coatings additives, with the proviso that the sum of all of the components makes 100% by weight

It is an advantage of the present invention that as a result of the presence of the cerium compound in conjunction with radiation curing the coating composition is cured thermally even in shadow regions and in pigmented coating compositions it is possible for curing to be initiated thermally.

The coating of the substrates takes place in accordance with typical methods known to the skilled worker, with at least one coating composition of the invention or a coating formulation comprising it being applied to the target substrate in the desired thickness and the volatile constituents of the coating composition being removed, with heating if appropriate. This operation can if desired be repeated one or more times. Application to the substrate may take place in a known way, such as by spraying, trowelling, knife coating, brushing, rolling, roller coating or pouring, for example. The coating thickness is generally situated within a range from about 3 to 1000 g/m² and preferably 10 to 200 g/m².

Additionally disclosed is a method of coating substrates, in which the coating composition of the invention or coating formulations comprising it, admixed if appropriate with thermally curable resins, is applied to the substrate and, if appropriate, dried, cured with electron beams or by UV exposure under an oxygen-containing atmosphere or, preferably, under inert gas, if appropriate at temperatures up to the level of the drying temperature, and subsequently treated thermally at temperatures up to 160° C., preferably between 60 and 160° C.

The method of coating substrates can also be carried out by first applying the coating composition or coating formulation of the invention and then initially carrying out thermal treatment at temperatures up to 160° C., preferably between 60 and 160° C., and subsequently carrying out curing with electron beams or by UV exposure under oxygen or, preferably, under inert gas.

Curing of the films formed on the substrate may if desired take place exclusively by means of heat. In general, however, the coatings are cured both thermally and by exposure to high-energy radiation.

If two or more coats of the coating material are applied over one another, it is possible if appropriate to carry out thermal and/or radiation curing after each coating operation.

Examples of suitable radiation sources for the radiation cure include low-pressure, medium-pressure or high-pressure mercury lamps, and also fluorescent tubes, pulsed lamps, metal halide lamps, electronic flash installations, which enable radiation curing without photoinitiator, or excimer emitters. The radiation cure is accomplished by exposure to high-energy radiation, i.e., UV radiation or daylight, preferably light in the wavelength range λ=200 to 700 nm, more preferably of 200 to 500 nm, and very preferably of 250 to 400 nm, or by exposure to high-energy electrons (electron beams; 150 to 300 keV). Examples of radiation sources used include high-pressure mercury vapor lamps, lasers, pulsed lamps (flashlight), halogen lamps or excimer emitters. The radiation dose usually sufficient for crosslinking in the case of UV curing is situated within the range from 80 to 3000 mJ/cm².

It will be appreciated that two or more radiation sources can also be used for the cure, from two to four for example.

These sources may also each emit in different wavelength ranges.

Drying and/or thermal treatment may also take place, in addition to or instead of the thermal treatment, by means of NIR radiation, NIR radiation here identifying electromagnetic radiation in the wavelength range from 760 nm to 2.5 μm, preferably from 900 to 1500 nm.

Irradiation can if appropriate also be carried out in the absence of oxygen, under an inert gas atmosphere for example. Suitable inert gases include, preferably, nitrogen, noble gases, carbon dioxide, or combustion gases. Irradiation may additionally take place with the coating composition covered with transparent media. Examples of transparent media are polymeric films, glass or liquids, water for example. Particular preference is given to irradiation in the manner described in DE-A1199 57 900.

The invention additionally provides a method of coating substrates which comprises
i) coating a substrate with a coating composition as described above,
ii) removing volatile constituents of the coating composition for film formation under conditions in which the photoinitiator as yet forms substantially no free radicals,
iii) if appropriate, irradiating the film formed in step ii) with high-energy radiation, the film being precured, and then, if appropriate, subjecting the article coated with the precured film to mechanical working, or contacting the surface of the precured film with another substrate,
iv) completing the cure of the film thermally

In this method, steps iv) and iii) may also be carried out in opposite order; in other words, the film can be cured first thermally and then with high-energy radiation.

The coating compositions of the invention and coating formulations comprising them are especially suitable for coating substrates such as wood, paper, textile, leather, nonwoven, plastics surfaces, glass, ceramic, mineral building materials, such as molded cement blocks and fiber cement slabs, or coated or uncoated metals, preferably plastics or metals.

With particular preference the coating compositions of the invention are suitable as or in exterior coatings, hence in those applications involving daylight exposure, preferably on buildings or parts of buildings, and as or in interior coatings, road markings, coatings on vehicles and aircraft. In particular the coating compositions of the invention are used as or in automotive clearcoat and topcoat materials.

The examples which follow are intended to illustrate the properties of the invention but without imposing any restriction thereon.

### EXAMPLES

“Parts” or “%” in this specification, unless indicated otherwise, are “parts by weight” of “% by weight”.

### Inventive Example 1

### Cerium(IV) as a Thermal Initiator in Dual Cure Systems

A mixture of 33% by weight of an allophanate formed from hexamethylene diisocyanate and Hydroxyethyl acrylate as described in WO 00/39183, p. 24, Table 1 and 54% by weight of Laromer® LR 8765 from BASF AG (aliphatic urethane acrylate in 1,6-hexanediol diacrylate, corresponding to an NCO/OH ratio of 1) was admixed with an initiator system comprising a mixture of 1.5% by weight of Lucirin® TPO from BASF AG, 0.5% by weight of Ce(NH₄)₂(NO₃)₆ and 11% by weight of ethanol.

The formulation was knife coated onto a glass plate so that the dry film had a thickness of 100 μm. After the plate had been heated at 120° C. for 20 minutes, a relatively hard, tack-free film was obtained (pendulum hardness by DIN 53157: 173 s).

FTIR spectroscopy demonstrated complete conversion of the NCO groups and acrylate groups.

For the NIR spectroscopy, films of the above formulation 2 mm thick were prepared and heated at 80° C. After 18 hours complete conversion of the acrylate band was apparent in the IR spectra.

### Comparative Example 1

The coating composition from Inventive example 1 but without the cerium compound was subjected to analogous application and thermal treatment.

Even after heating at 120° C. for 21 hours, the film remained liquid.

For the NIR spectroscopy films of the above formulation 2 mm thick were prepared and were heated at 80° C. After 18 hours the IR spectra indicated virtually no conversion of the acrylate band.

### Inventive Examples 2 and 3

When additionally subjected to radiation, the above formulation can be regarded as a dual cure system, in which three types of curing mechanism take place:
thermal curing of isocyanate/alcohol
thermal curing of the acrylate function, initiated by Ce(IV)
radiation curing of the acrylate function, initiated by photoinitiator

A mixture of 33% by weight of an allophanate formed from hexamethylene diisocyanate and hydroxyethyl acrylate as described in WO 00/39183, p. 24, Table 1 and 54% by weight of Laromer® LR 8765 from BASF AG (aliphatic epoxy acrylate, corresponding to an NCO/OH ratio of 1) was admixed with an initiator system comprising a mixture of 1.5% by weight of Lucirin® TPO from BASF AG, 0.5% by weight of Ce(NH₄)₂(NO₃)₆ and 11% by weight of ethylene glycol.

The formulation was knife coated onto a glass plate so that the dry film had a thickness of 16 μm. UV curing was carried out in air with a UV dose of 0.4 J cm⁻². FTIR spectroscopy was used to determine the relative conversions of the NCO and acrylate functions.

| | | Relative | | | Relative | |
|---|---|---|---|---|---|---|
| | | conversions | | | conversions | |
| | | [%] | | | [%] | |
| Example | 1st step | NCO | C═C | 2nd step | NCO | C═C |
| 2 | UV | 6 | 94 | 60 min. 80° C. | 38 | 96 |
| 3 | 60 min. | 100 | 79 | UV | 100 | 82 |
| | 80° C. | | | | | |

1-10. (canceled)

11. A coating composition comprising
at least one cerium(IV) compound,
either
at least one compound A having at least one isocyanate-reactive group and at least one free-radically polymerizable unsaturated group and
at least one isocyanato-functional compound B,
or
at least one compound C having at least one isocyanate group and at least one free-radically polymerizable unsaturated group and
at least one compound D having at least one isocyanate-reactive group,
and optionally
at least one photoinitiator,
at least one solvent,
at least one free-radically polymerizable monomer,
at least one polyfunctional polymerizable compound, and
typical coatings additives.

12. The coating composition of claim 11, wherein said cerium(IV) compound is selected from the group consisting of ammonium hexanitratocerate(IV) (cerium(IV) ammonium nitrate, (NH₄)₂[Ce(NO₃)₆]), sodium hexanitratocerate(IV) (Na₂[Ce(NO₃)₆]), potassium hexanitratocerate(IV) (K₂[Ce(NO₃)₆]), cerium(IV) ammonium sulfate, cerium(IV) hydroxide, cerium(IV) isopropoxide/isopropanol complex, cerium(IV) oxide (CeO₂), and cerium(IV) sulfate (Ce(SO₄)₂).

13. The coating composition of claim 11, wherein said cerium(IV) compound in the coating composition is obtained by oxidizing cerium compounds in a lower oxidation state.

14. The coating composition of claim 13, cerium compounds in a lower oxidation state are cerium (III) compounds.

15. The coating composition of claim 11, wherein the at least one compound A having at least one isocyanate-reactive group and at least one free-radically polymerizable unsaturated group selected from the group consisting of 2-hydroxyethyl (meth)acrylate, 2- or 3-hydroxypropyl(meth)acrylate, 1,4-butanediol mono(meth)acrylate, neopentyl glycol mono(meth)acrylate, glycerol mono- and di(meth)acrylate, trimethylolpropane mono- and di(meth)acrylate, pentaerythritol mono-, di-, and tri(meth)acrylate, and 4-hydroxybutyl vinyl ether, 2-aminoethyl(meth)acrylate, 2-aminopropyl(meth)acrylate, 3-aminopropyl(meth)acrylate, 4-aminobutyl(meth)acrylate, 6-aminohexyl(meth)acrylate, 2-thioethyl(meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide, and the reaction products of (meth)acrylic acid with bisphenol A diglycidyl ether, bisphenol F diglycidyl ether, 1,4-butanediol diglycidyl ether, 1,6-hexanediol diglycidyl ether, trimethylolpropane triglycidyl ether and pentaerythritol tetraglycidyl ether.

16. The coating composition of claim 11, wherein said at least one isocyanoto-functional compound B is a diisocyanate having 4 to 20 carbon atoms.

17. The coating composition of claim 16, wherein said diisocyanate is an aliphatic or cycloaliphatic diisocyanate.

18. A method of coating substrates which comprises coating a substrate with the coating composition of claim 11.

19. A substrate coated with a coating composition of claim 11.

20. The method of using cerium(IV) compounds in dual-cure curing.
